(19) United States
(12) Patent Application Publication
(10) Pub. No.: US 2013/0086176 A1
(43) Pub. Date: Apr. 4, 2013

(54) DELAYED ELECTRONIC MAIL SENDING

(71) Applicants: KULVIR S. BHOGAL, PFLUGERVILLE, TX (US); WILLIAM A. GRIFFITH, AUSTIN, TX (US); MARK W. TALBOT, AUSTIN, TX (US)

(72) Inventors: KULVIR S. BHOGAL, PFLUGERVILLE, TX (US); WILLIAM A. GRIFFITH, AUSTIN, TX (US); MARK W. TALBOT, AUSTIN, TX (US)

(73) Assignee: INTERNATIONAL BUSINESS MACHINES CORPORATION, ARMONK, NY (US)

(21) Appl. No.: 13/249,462

(22) Filed: Sep. 30, 2011

(51) Int. Cl. G06F 15/16

(52) U.S. Cl. 709/206

(57) ABSTRACT

A method can include associating an electronic document with an electronic mail message as an attachment and determining that the electronic document is in an uncompleted state using a processor. The method can include replacing the electronic document with an updated version of the electronic document as the attachment to the electronic mail message and sending the electronic mail message with the updated version of the electronic document as the attachment responsive to detecting a completion condition for the electronic document.

### BACKGROUND

One or more embodiments disclosed within this specification relate to processing electronic mail messages. Electronic mail, in general, refers to a form of communication in which an originator or author can create an electronic message referred to as an electronic mail message or an “email” message using an electronic mail client. Through the electronic mail client, the email message can be sent through a communication network to one or more recipients or recipient electronic mail systems.

An email message can include a variety of different forms of content. In addition to text, for example, an email message can be associated with one or more electronic documents. Each electronic document associated with the email message can be sent with the email message in the form of an attachment. The recipient(s) of the email message can view the email message itself as well as open any attachment(s) that may have been included.

### BRIEF SUMMARY

One or more embodiments disclosed within this specification relate to processing electronic mail (email) messages and, more particularly, to sending email messages that include “up-to-date” attachments or attachments considered to be in a “completed” state.

An embodiment can include a method. The method can include associating an electronic document with an email message as an attachment and determining that the electronic document is in an uncompleted state using a processor. The method can include replacing the electronic document with an updated version of the electronic document as the attachment to the email message and sending the email message with the updated version of the electronic document as the attachment responsive to detecting a completion condition for the electronic document.

Another embodiment can include a system. The system can include a computer readable storage medium having computer readable program code embodied therewith and a processor coupled to the computer readable storage medium. Responsive to executing the computer readable program code, the processor can be configured to perform the various operations described within this specification.

Another embodiment can include a computer program product. The computer program product can include a computer readable storage medium having computer readable program code embodied therewith. The computer readable program code can include computer readable program code configured for performing the various operations described within this specification.

### BRIEF DESCRIPTION OF THE SEVERAL VIEWS OF THE DRAWINGS

FIG. 1 is a block diagram illustrating a system for electronic mail in accordance with an embodiment disclosed within this specification.

FIG. 2 is a block diagram illustrating a client system described with reference to FIG. 1 in accordance with another embodiment disclosed within this specification.

FIG. 3 is a flow chart illustrating a method of processing electronic mail messages in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One or more embodiments disclosed within this specification relate to processing electronic mail (email) messages and, more particularly, to sending email messages that include “up-to-date” attachments or attachments considered to be in a “completed” state. In accordance with the inventive arrangements disclosed within this specification, a client system can be configured for processing email messages. The client system can be configured to determine when an electronic document attached to an email message is in an uncompleted state.

The client system can determine that the electronic document is not complete through any of a variety of different techniques to be described within this specification in greater detail. Accordingly, the client system can store the email message in lieu of sending until a completion condition is detected that relates to the electronic document attached to the email message. Responsive to detecting the completion condition, the client system can be configured to update the email message to include an updated, or completed, version of the electronic document as the attachment. Once updated, the client system can send the email message with the updated version of the electronic document as the attachment in lieu of any prior versions of the electronic document that were considered incomplete.

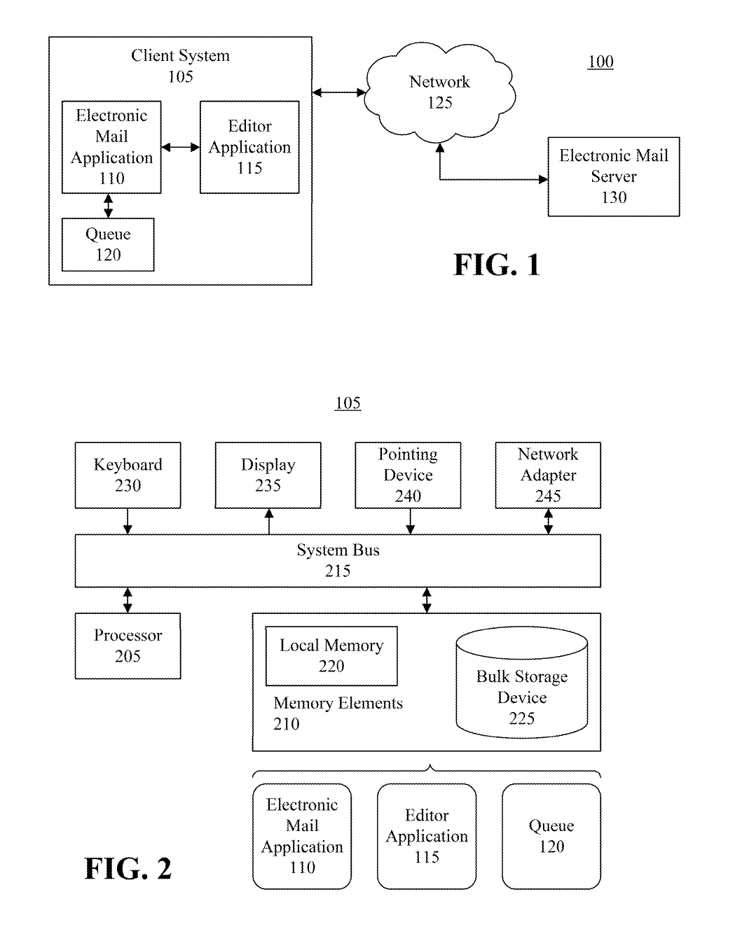

FIG. 1 is a block diagram illustrating a system 100 for electronic mail in accordance with an embodiment disclosed within this specification. System 100 can include a client system 105. Client system 105 can be coupled, e.g., communicatively linked, with a network 125. An email server 130 also can be coupled, e.g., communicatively linked, with network 125. Accordingly, client system 105 and email server 130 can communicate with one another over network 125.

Client system 105 can be implemented as a data processing system. As such, client system 105 can in include, or execute, an email application 110, an editor application 115, and a queue 120. Through execution of email application 110, client system 105 can be used by a user to create, edit, send, and/or receive email messages.

In an embodiment, email application 110 can be configured to communicate with editor application 115. For example, email application 110 can be configured to register, or subscribe, to receive events generated by editor application 115. For example, editor application 115 can be configured to receive registration requests from other applications such as email application 110. In response to the registration request, editor application 115 can send events to email application 110. In one example, the registration functionality can be implemented within editor application 115 through inclusion or installation of a “plug-in” type of computer program component, presuming editor application 115 provides an infrastructure for incorporating plug-ins. In another example, editor application 115 can be configured to support registrations without the inclusion of a plug-in.

Editor application 115 can be implemented as any of a variety of applications that can be used to create, edit, or modify an electronic document, e.g., an electronic file. Illustrative examples of editor application 115 can include, but are not limited to, a word processor application, a spread sheet application, an audio editing or recording application, a video editing application, or the like. As such, examples of electronic documents, or files, discussed within this specification that can be associated with an email message and sent as an attachment to the email message can include various file types such as text documents, markup language documents, word processing documents, spreadsheet documents, audio files, video files, or the like. The particular type of editor application and/or electronic document used as an attachment to an email message is not intended as a limitation of the one or more embodiments disclosed within this specification.

Queue 120 can refer to a managed memory space that can be used to store or hold email messages on a temporary basis. Queue 120 can store email messages prior to being sent from client system 105 to email server 130 via network 125. In one aspect, queue 120 can be implemented as an application that exists separately from email application 110, but that can function cooperatively with email application 110. In another aspect, though illustrated separately, queue 120 can be part of, or included within, email application 110.

In general, client system 105 can be used to create one or more email messages. The email messages can be processed and stored within queue 120 under particular circumstances. For example, responsive to determining that an email message has an attachment that is determined to be in an uncompleted state, email application 110 can store the email message within queue 120 in lieu of sending the email message. Email application 110 can store the email message in queue 120 pending the detection of one or more completion conditions that are correlated with the email message in queue 120.

Responsive to detecting the completion condition(s), email application 110 can replace the electronic document stored, and associated, with the email message as an attachment within queue 120 with an updated version, e.g., a completed version, of the electronic document. Once the email message includes the updated or completed version of the electronic document, email application 110 can send the email message with the updated version of the electronic document as an attachment to email server 130 via network 125 for further processing or delivery to the intended recipient. In this example, network 125 can represent the Internet. It should be appreciated, however, that network 125 can represent, or include, one or more LANs, WANs, wireless networks, mobile networks, or the like.

FIG. 2 is a block diagram illustrating client system 105 of FIG. 1 in accordance with another embodiment disclosed within this specification. Like numbers will be used to refer to the same items throughout this specification. As shown, client system 105 can include at least one processor 205 coupled to memory elements 210 through a system bus 215. Accordingly, client system 105 can store program code within memory elements 210. Processor 205 can execute the program code accessed from memory elements 210 via system bus 215.

In one aspect, for example, client system 105 can be implemented as a computer that is suitable for storing and/or executing program code. It should be appreciated, however, that client system 105 can be implemented in the form of any system that includes a processor and memory that is capable of performing the functions described within this specification. For example, client system 105 can be implemented in the form of a portable computer, a tablet computer, a mobile communication device, or the like in any of a variety of different form factors.

Memory elements 210 can include one or more physical memory devices such as, for example, local memory 220 and one or more bulk storage devices 225. Local memory 220 refers to random access memory or other non-persistent memory device(s) generally used during actual execution of the program code. Bulk storage device(s) 225 can be implemented as a hard drive, solid state drive, or other persistent data storage device. Client system 105 also can include one or more cache memories (not shown) that provide temporary storage of at least some program code in order to reduce the number of times program code must be retrieved from bulk storage device 225 during execution.

Input/output (I/O) devices such as a keyboard 230, a display 235, and a pointing device 240, e.g., a mouse, optionally can be coupled to client system 105. In another aspect, display 235 can be configured as a touch sensitive display capable of receiving user input. The I/O devices can be coupled to client system 105 either directly or through intervening I/O controllers. A network adapter 245 also can be coupled to client system 105 to enable client system 105 to become coupled to other systems, computer systems, remote printers, and/or remote storage devices such as electronic mail server 130 through intervening private or public networks, e.g., network 125. Modems, cable modems, and Ethernet cards are examples of different types of network adapter 245 that can be used with system 105.

As pictured in FIG. 1, memory elements 210 can store email application 110, editor application 115, and queue 120. Email application 115, editor application 115, and/or queue 120 can be implemented in the form of executable program code and, as such, can be executed by client system 105 and, more particularly, by processor 205, to implement the various functions and/or operations described within this specification.

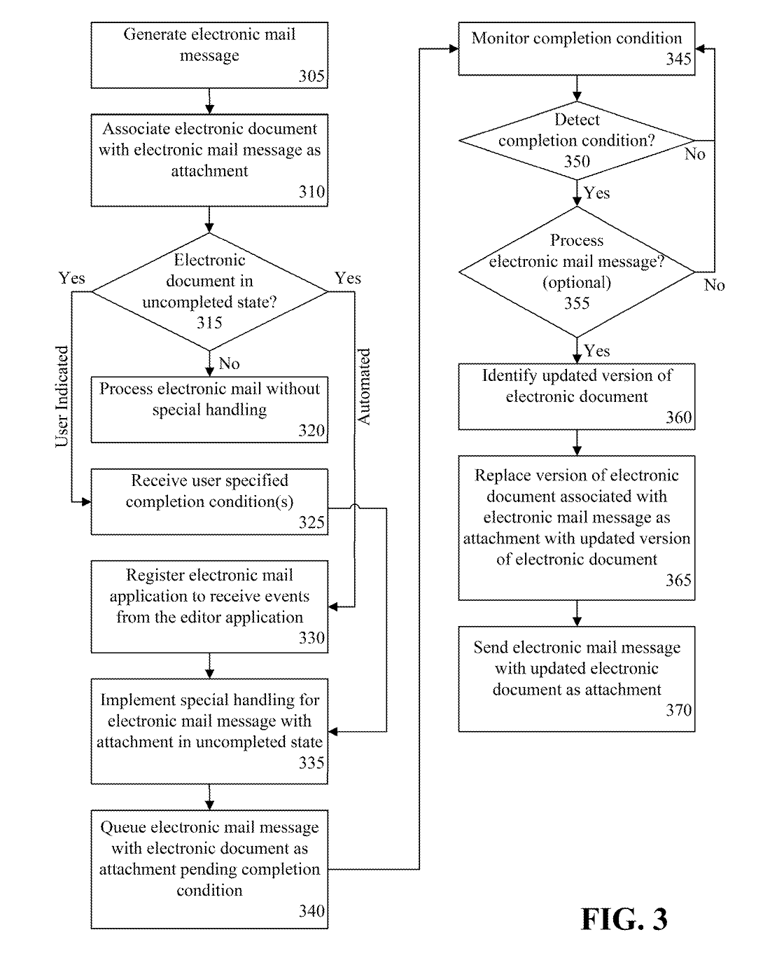

FIG. 3 is a flow chart illustrating a method 300 of processing email messages in accordance with another embodiment disclosed within this specification. Method 300 can be implemented by a system such as the client system described with reference to FIGS. 1 and 2 of this specification.

For purposes of description and illustration, it should be appreciated that when an attribute and/or condition is associated with an email message, the attribute and/or condition is also associated with any electronic documents that have been, or will be, associated with the email message as attachments. Accordingly, although not specifically stated that a particular attribute or condition is associated with an electronic document, the attribute and/or condition is associated with the electronic document at least by virtue of the association of the attribute and/or condition with the email message to which the electronic document is or will be attached. Similarly, any association of a state, e.g., an uncompleted state, with an electronic document can be carried forward to the particular email message to which that electronic document is or will be attached. In this regard, an email message having an electronic document as an attachment that is in an uncompleted state also can be referred to as being in an uncompleted state.

Method 300 can begin in step 305 where the email application can generate an email message. For example, responsive to a user input, the email application can generate a new email message. The user can fill in the various address fields and further write or add content such as text in the body of the email message as normal. In step 310, the email application can associate a selected electronic document with the email message generated in step 305 as an attachment to the email message. For example, responsive to a user input requesting to attach an electronic document to the email message, the user can be presented with a graphical user interface (GUI) through which the user can select the particular electronic document or documents to be associated with the email message as attachment(s). It should be appreciated that in an embodiment, the email application can store or otherwise retain the path specifying the unique location of the electronic document identified by the user for attachment. The path, e.g., the full path, can be stored with, or as part of, the email message, for example.

In step 315, the email application can determine whether the electronic document attached to the email message is in an uncompleted state. In one aspect, the user can provide one or more inputs to the email application indicating that the electronic document associated with the email message as an attachment is unfinished, e.g., in the uncompleted state. For example, the particular GUI presented to the user to locate the electronic document can include a field or control that, when activated or selected by the user, indicates to the email application that the particular file specified within the GUI by the user is in the uncompleted state.

It should be appreciated that the user can indicate that the email message, and thus any electronic document attached thereto, is in an uncompleted state at any of a variety of times before, during, or/or after associating the electronic document with the email message as an attachment. For example, the user specified indication that the electronic document is in an uncompleted state can be received virtually any time prior to an instruction to send the email message. As such, the examples discussed within this specification are provided for purposes of illustration only. Responsive to the user indicating that the electronic document is in an uncompleted state, method 300 can follow the “user indicated” path and proceed to step 325.

In step 325, the email application can receive one or more user specified completion conditions that can be associated with the email message. For example, the user can specify a time, e.g., a time and date, that can be associated with the email message. In another example, the user can specify a plurality of completion conditions such as a time followed by “and if not open” indicating that the completion condition occurs only when the designated time occurs and the electronic document is not open by another application.

In another aspect, the determination of whether the electronic document associated with the email message as an attachment is in an uncompleted state can be performed in a more, or fully, automated manner. For example, responsive to associating the electronic document with the email message as an attachment, the email application can determine whether the electronic document is currently open within, or by, another application that may be executing within the client system. Responsive to the email application determining that the electronic document is in an uncompleted state automatically by detecting that the electronic document is opened within another application, method 300 can proceed to step 330. For example, in one aspect, the email application can query the operating system to obtain a list of files that are currently open or, if the functionality is available, query the operating system as to whether the electronic document in particular is open. The email application can make a determination based upon the response received from the operating system.

In step 330, the email application can register to receive events from the application in which the electronic document is opened, e.g., the editor application for purposes of description. Examples of different types of events that can be received from the editor application by the email application as a consequence of registration can include, but are not limited to, save events indicating that the electronic document has been saved by the editor application, a close event indicating that the electronic document has been closed and, therefore, is no longer open within the editor application, or the like.

In an embodiment, the email application, responsive to determining that the electronic document associated with the email message as an attachment is in an uncompleted state, can flag the email message as requiring special handling. The email application can flag the email message irrespective of whether the user indicated that the electronic document was in an uncompleted state or the email application detected the uncompleted state automatically.

Responsive to the email application determining that the electronic document is not in an uncompleted state, method 300 can continue to step 320. In step 320, the email application can process the email message without special handling. In that case, for example, the email application does not queue the email message while awaiting a completion condition. In this regard, the email application can associate the electronic document selected by the user with the email message as an attachment. Responsive to the email application receiving a user input specifying that the email message should be sent, the email application can send the email message with the electronic document as an attachment to the email server.

Continuing with step 335, the email application can implement special handling for the email message, i.e., an email message that has been flagged and, thus, has an attachment in an uncompleted state. In step 340, the email application can store the email message, including the electronic document attached to the email message in a queue. In one aspect, for example, responsive to a user input, such as a user input requesting to send the email message, the email message can be stored in the queue. Any email message identified as requiring special handling, for example, can be queued responsive to the user input or a send instruction.

As discussed, the email application can await the occurrence of one or more completion conditions before processing the email message any further. It should be appreciated that the presence of the email message within the queue can indicate that the email message requires special handling or has been designated for the type of special handling described within this specification, e.g., delayed sending.

Accordingly, the email application can begin monitoring for the occurrence of a completion condition for the email message in step 345. In step 350, the email application can determine whether a completion condition has been detected. Any of a variety of different completion conditions can be detected. Further, the completion conditions can be detected using any of a variety of different detection mechanisms.

In one aspect, the completion condition can refer to the occurrence of any user specified completion condition or conditions associated with the email message that may be detected by the email application. Referring to the prior example, responsive to the email application detecting the occurrence of the completion condition, e.g., the occurrence of a specified time associated with the queued email message, the email application can determine that the completion condition has occurred or been detected at least for the email message with which the time was associated.

In another aspect, for example, when the email application has registered to receive events from an editor application in which the electronic document is open, the email application can receive an event from the editor application relating to the electronic document. For example, one or more predetermined events such as a save event or a close event for the electronic document, when received by the email application from the editor application with which the email application registered, can be interpreted by the email application as the completion condition for the queued email message.

Though a registration process has been described, in another aspect, the email application can poll or query the operating system from time-to-time or periodically as to whether the electronic document is open. In another example, the email application can query the operating system to obtain a list of files currently open in the operating system. The email application can determine, for example, that the electronic document is complete when the operating system indicates that the file is no longer open.

Responsive to the email application determining that a completion condition has been detected, method 300 can proceed to step 355. Otherwise, method 300 can loop back to step 345 to continue monitoring for the occurrence of a completion condition relating to the email message stored within the queue.

In step 355, the email application optionally can query the user as to whether the email application should process the email message in the queue. For example, the email application can query the user whether the received event(s) should be interpreted as a completion condition, e.g., whether the electronic document is completed. In some cases, a user can save a document periodically while working. Accordingly, the save operation and event may not accurately indicate that the electronic document is completed. Responsive to a user input indicating that the email application should not process the email message, e.g., the electronic document is still in an uncompleted state, method 300 can loop back to step 345 to continue monitoring for a further completion condition. Responsive to a user input indicating that the email application should process the email message since the electronic document associated with the email message as an attachment is now complete, e.g., the electronic document is no longer in the uncompleted state, method 300 can continue to step 360.

In step 360, the email application can identify an updated version of the electronic document. For example, the email application can access the stored path for the electronic document and obtain the most recent version of the electronic document available from the location specified by the stored path. In step 365, the email application can replace the version of the electronic document currently associated with the email message as an attachment with the updated version of the electronic document identified in step 360. For example, the email application can remove or delete the electronic document currently attached to the email message and then associate the updated version of the electronic document with the email message as an attachment. In step 370, the email application can send the email message with the updated electronic document as the attachment.

In another aspect, the email application can have more than one email message queued. In that case, when an event is received, the event can be correlated to the correct email message, and thus electronic document, based upon the stored path of the electronic document associated with the electronic message as an attachment. The event, for example, can indicate the path of the file to which the event pertains, which can be matched to the stored path of the electronic document attached to a queued email message. In this manner, an event can be correlated to the appropriate one of a plurality of different email messages queued for later sending pending the completion of the attachment to the email message. A similar process can be performed with respect to operating system queries, e.g., where files specified as being open by the operating system can be correlated with the correct email message according to the path of the file as returned by the operating system matched to the stored path of the electronic documents associated with queued email messages. When a given electronic document can no longer be matched to an open file as specified by the operating system, the electronic document can be considered completed.

The one or more embodiments disclosed within this specification provide various techniques that allow a user to create an email message and further specify the conditions that must be detected before that email message can be sent. The conditions can specify, for example, when an electronic document that is associated with the email message as an attachment is no longer considered to be in an uncompleted state. Responsive to determining that completion condition has occurred indicating that the electronic document is no longer in an uncompleted state, the email message can be updated with the most recent or up-to-date version of the electronic document as the attachment and then sent.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method comprising:
associating an electronic document with an electronic mail message as an attachment;
determining that the electronic document is in an uncompleted state using a processor; and
responsive to detecting a completion condition for the electronic document, replacing the electronic document with an updated version of the electronic document as the attachment to the electronic mail message and sending the electronic mail message with the updated version of the electronic document as the attachment.

2. The method of claim 1, further comprising:
queuing the electronic mail message until the completion condition is detected.

3. The method of claim 1, wherein determining that the electronic document is in an uncompleted state comprises:
detecting that the electronic document is currently open.

4. The method of claim 1, wherein determining that the electronic document is in an uncompleted state comprises:
receiving a user input specifying that the electronic document is in the uncompleted state.

5. The method of claim 1, wherein:
the completion condition is an occurrence of a particular time.

6. The method of claim 1, wherein:
the completion condition is a save of the electronic document.

7. The method of claim 1, wherein:
the completion condition is an exit from an editor application in which the electronic document is open.

8. The method of claim 1, further comprising:
responsive to detecting a save of the electronic document, querying a user to determine whether the electronic document is still in an uncompleted state,
wherein the replacing of the electronic document with the updated version of the electronic document as an attachment to the electronic mail message and the sending of the electronic mail message with the updated version of the electronic document as the attachment is performed responsive to a user input indicating that the electronic document is no longer in the uncompleted state responsive to the querying.

9. A system comprising:
a computer readable storage medium having computer readable program code embodied therewith; and
a processor coupled to the computer readable storage medium, wherein responsive to executing the computer readable program code, the processor is configured to:
associate an electronic document with an electronic mail message as an attachment;
determine that the electronic document is in an uncompleted state; and
responsive to detecting a completion condition for the electronic document, replace the electronic document with an updated version of the electronic document as an attachment to the electronic mail message and send the electronic mail message with the updated version of the electronic document as the attachment.

10. The system of claim 9, wherein the processor is further configured to:
queue the electronic mail message until the completion condition is detected.

11. The system of claim 9, wherein the processor is configured to:
determine that the electronic document is in an uncompleted state by detecting that the electronic document is currently open.

12. The system of claim 9, wherein:
the completion condition is a save of the electronic document.

13. A computer program product comprising:
a computer readable storage medium having computer readable program code embodied therewith, the computer readable program code comprising:
computer readable program code configured to associate an electronic document with an electronic mail message as an attachment;
computer readable program code configured to determine that the electronic document is in an uncompleted state; and
computer readable program code configured to replace the electronic document with an updated version of the electronic document as an attachment to the electronic mail message and send the electronic mail message with the updated version of the electronic document as the attachment responsive to detecting a completion condition for the electronic document.

14. The computer program product of claim 13, wherein the computer readable program code further comprises:
computer readable program code configured to queue the electronic mail message until the completion condition is detected.

15. The computer program product of claim 13, wherein the computer readable program code configured to determine that the electronic document is in an uncompleted state comprises:
computer readable program code configured to detect that the electronic document is currently open.

16. The computer program product of claim 13, wherein the computer readable program code configured to determine that the electronic document is in an uncompleted state comprises:
computer readable program code configured to receive a user input specifying that the electronic document is in the uncompleted state.

17. The computer program product of claim 13, wherein the completion condition is an occurrence of a particular time.

18. The computer program product of claim 13, wherein the completion condition is a save of the electronic document.

19. The computer program product of claim 13, wherein the completion condition is an exit from an editor application in which the electronic document is open.

20. The computer program product of claim 13, wherein the computer readable program code further comprises:
computer readable program code configured to query a user to determine whether the electronic document is still in an uncompleted state responsive to detecting a save of the electronic document,
wherein the computer readable program code configured to replace of the electronic document with the updated version of the electronic document as an attachment to the electronic mail message and send of the electronic mail message with the updated version of the electronic document as the attachment is operative responsive to a user input indicating that the electronic document is no longer in the uncompleted state received in response to the query.
